(19) United States
(12) Patent Application Publication
(10) Pub. No.: US 2016/0046015 A1
(43) Pub. Date: Feb. 18, 2016

(54) Slip-Proof Hand Tool

(71) Applicant: Chia-Szu Lin, Taichung City (TW)

(72) Inventor: Chia-Szu Lin, Taichung City (TW)

(21) Appl. No.: 14/458,508

(22) Filed: Aug. 13, 2014

(51) Int. Cl. B25G 1/10

(52) U.S. Cl. CPC B25G 1/102; B25G 1/105

(57) ABSTRACT

A slip-proof hand tool has a hand tool body and a slip-proof sleeve. The hand tool body has a handle and at least one working end. The handle has two handle fixing holes formed through the handle and respectively adjacent to two ends of the handle. The at least one working end is connected with the handle. The slip-proof sleeve is mounted around the handle and has two fixing portions and a body. The fixing portions are mounted around the handle, are respectively adjacent to the ends of the handle, and are respectively inserted through the handle fixing holes. The body is connected between the fixing portions and has at least one slip-proof portion formed on a side of the body and adjacent to the at least one working end.

### BACKGROUND OF THE INVENTION

1. Field of the Invention

The present invention relates to a hand tool, and more particularly to a slip-proof hand tool.

2. Description of Related Art

With reference to FIG. 5, a conventional slip-proof hand tool has a hand tool body 50 and a slip-proof sleeve 60. The hand tool body 50 has a handle 51. The slip-proof sleeve 60 is mounted around the handle 51 and has multiple slip-proof blocks 61. The slip-proof blocks 61 are formed on the slip-proof sleeve 60, such that the slip-proof sleeve 60 has an uneven surface and a high frictional coefficient.

However, the slip-proof hand tool is not fixed around the hand tool body 50, so when in use, the slip-proof sleeve 60 may be displaced relative to the hand tool body 50.

### SUMMARY OF THE INVENTION

The main objective of the present invention is to provide a slip-proof hand tool to resolve the afore-mentioned problems.

The slip-proof hand tool has a hand tool body and a slip-proof sleeve.

The hand tool body has a handle and at least one working end. The handle has two ends and two handle fixing holes formed through the handle and being respectively adjacent to the ends of the handle. The at least one working end is connected with the handle.

The slip-proof sleeve is mounted around the handle and has two fixing portions and a body. The fixing portions are mounted around the handle, are respectively adjacent to the ends of the handle, and are respectively inserted through the handle fixing holes. The body is connected between the fixing portions and has at least one slip-proof portion formed on a side of the body and being adjacent to the at least one working end.

Other objectives, advantages and novel features of the present invention will become more apparent from the following detailed description when taken in conjunction with the accompanying drawings.

### BRIEF DESCRIPTION OF THE DRAWINGS

FIG. 1 is a perspective view of a preferred embodiment of a slip-proof hand tool in accordance with the present invention;

FIG. 2 is a perspective view in partial section of the slip-proof hand tool in FIG. 1;

FIG. 3 is a cross sectional side view of the slip-proof hand tool in FIG. 1;

FIG. 4 is an operational perspective view of the slip-proof hand tool in FIG. 1; and

FIG. 5 is a perspective view of a conventional slip-proof hand tool.

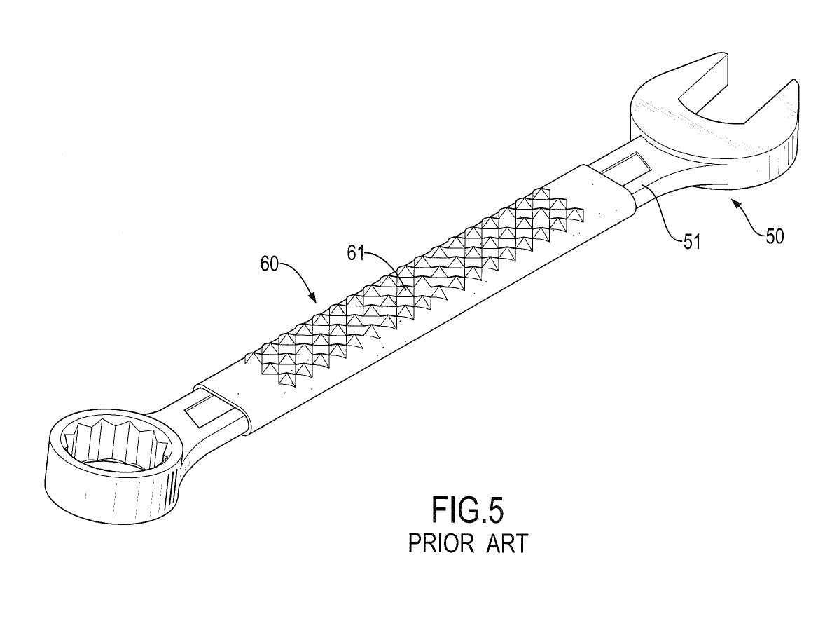

### DETAILED DESCRIPTION OF PREFERRED EMBODIMENT

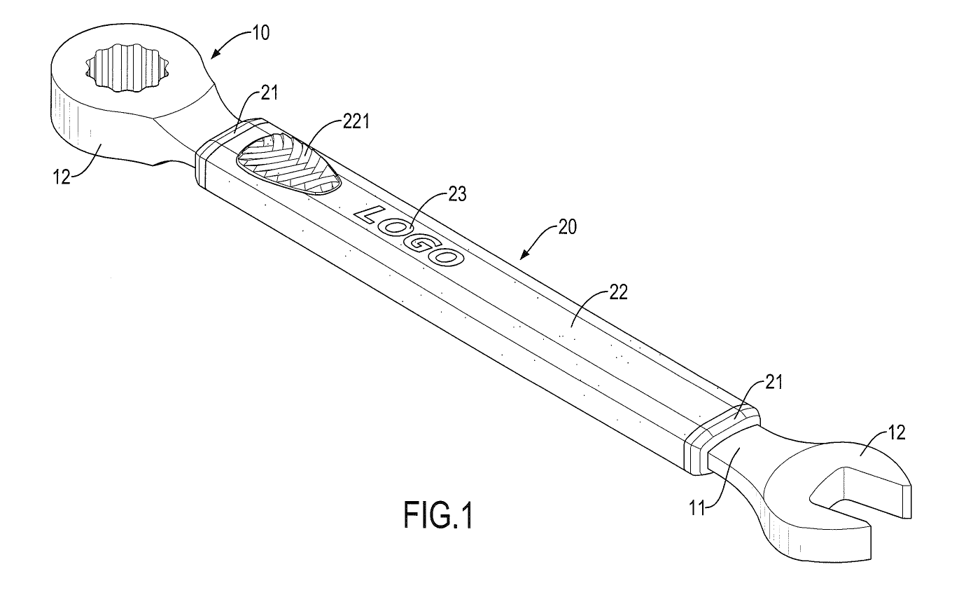

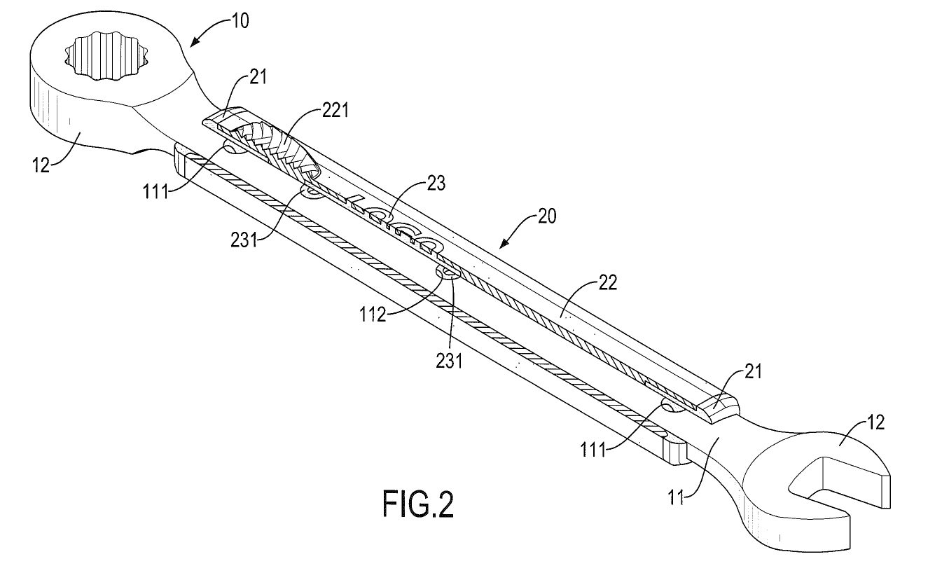

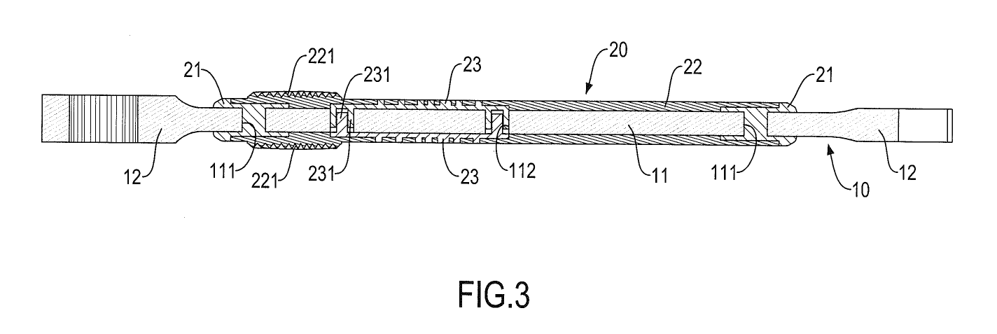

With reference to FIGS. 1 to 3, a preferred embodiment of a slip-proof hand tool in accordance with the present invention has a hand tool body 10 and a slip-proof sleeve 20.

The hand tool body 10 has a handle 11 and two working ends 12. The working ends 12 are respectively connected with two ends of the handle 11. The working ends 12 may be respectively formed as different tool joints. The handle 11 has two handle fixing holes 111 and two handle decorating holes 112. The handle fixing holes 11 are formed through the handle 11 and are respectively located adjacent to the working ends 12. The handle decorating holes 112 are formed through the handle 11 at an interval.

The slip-proof sleeve 20 is mounted around the handle 11 and has two fixing portions 21, two decorating portions 23 and a body 22. The fixing portions 21 are mounted around the handle 11 and are respectively adjacent to the working ends 12. The fixing portions 21 are respectively inserted through the handle fixing holes 111, such that the fixing portions 21 can be fixed around the handle 11.

The decorating portions 23 are mounted on two opposite sides of the handle 11. Each decorating portion 23 has two inserting portions 231 formed on a side of the decorating portion 23. The inserting portions 231 of each decorating portion 23 are respectively inserted into the handle decorating holes 112. The inserting portions 231 of one of the decorating portions 23 are detachably connected with the inserting portions 231 of the other decorating portion 23, such that the decorating portions 23 can be fixed on the handle 11.

The body 22 is connected between the fixing portions 21, covers the decorating portions 23, is mounted around the handle 11, and has two slip-proof portions 221. The slip-proof portions 221 are formed on two opposite sides of the body 22, and are adjacent to one of the working ends 12. Each slip-proof portion 221 has an uneven surface, such that the slip-proof portion 221 has a high frictional coefficient. Preferably, the slip-proof portions 221 may be made of hard plastic, and the body 22 may be made of soft plastic.

The decorating portions 23 are molded in advance. Then, the fixing portions 21 are formed by injection molding on the handle 11. The decorating portions 23 are then mounted on the handle 11. Finally, the body 22 is formed by injection molding around the handle 11 to connect between the fixing portions 21 and to cover the decorating portions 23, such that the slip-proof hand tool is manufactured.

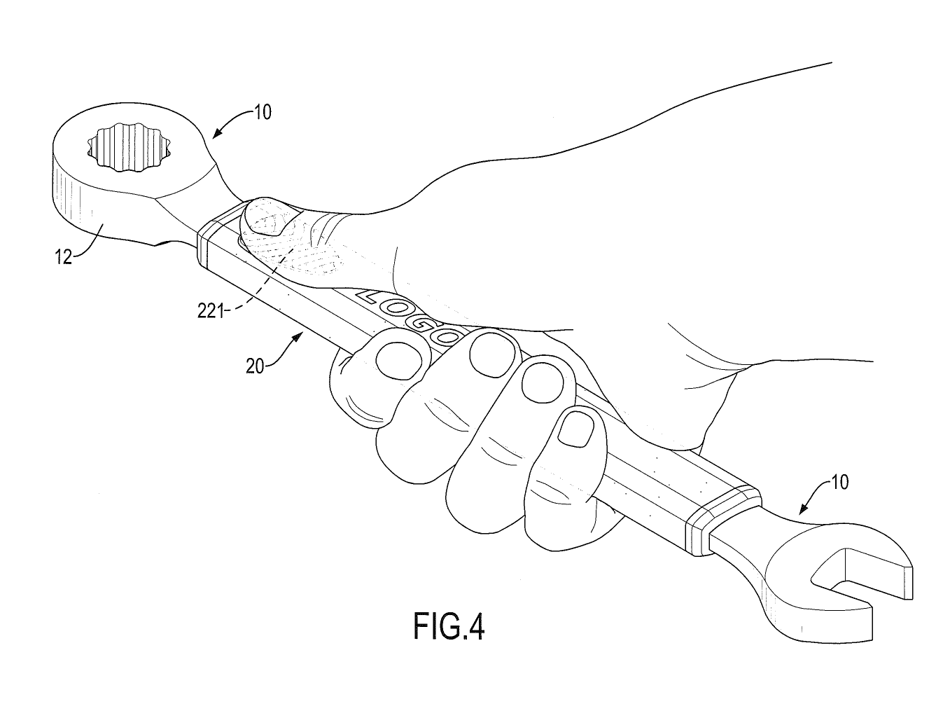

With reference to FIG. 4, in use, a user holds the slip-proof sleeve 20 and one of the working ends 12 is pointed at a point for operation. The user can press one of the slip-proof portions 221 to operate the hand tool body 10 easily.

Alternatively, the body 22 may have four slip-proof portions 221 formed on the opposite sides of the body 22, wherein two of the slip-proof portions 221 are adjacent to one of the working ends 12, and the other two slip-proof portions 221 are adjacent to the other working end 12. Therefore, regardless of which working end 12 is used, the user can press the corresponding slip-proof portion 221 to operate the hand tool body 10.

The slip-proof sleeve 20 is inserted through the handle fixing holes 111 and the handle decorating holes 112, such that a position of the slip-proof sleeve 20 can be fixed relative to the hand tool body 10.

From the above description, it is noted that the present invention has the following advantages:

1. The slip-proof sleeve 20 is mounted around the handle 11 and is inserted through the handle fixing holes 111 by the fixing portions 21, such that a position of the slip-proof sleeve 20 can be fixed relative to the hand tool body 10. Therefore, the user can operate the slip-proof hand tool easily.

2. The decorating portions 23 are mounted on the handle 11 by the inserting portions 231, such that the position of the slip-proof sleeve 20 can be further fixed corresponding to the decorating portions 23. Furthermore, the decorating portions 23 can provide an aesthetic appeal.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A slip-proof hand tool having:
a hand tool body having
a handle having
two ends; and
two handle fixing holes formed through the handle and being respectively adjacent to the ends of the handle;
at least one working end connected with the handle; and
a slip-proof sleeve mounted around the handle and having
two fixing portions mounted around the handle, being respectively adjacent to the ends of the handle, and respectively inserted through the handle fixing holes; and
a body connected between the fixing portions and having at least one slip-proof portion formed on a side of the body and being respectively adjacent to the at least one working end.

2. The slip-proof hand tool as claimed in claim 1, wherein
the handle further has at least one handle decorating hole formed through the handle; and
the slip-proof sleeve further has two decorating portions mounted on two opposite sides of the handle and covered by the body, wherein each decorating portion has at least one inserting portion formed on the decorating portion and inserted respectively into the at least one handle decorating hole, wherein the at least one inserting portion of one of the decorating portions is respectively connected with the at least one inserting portion of the other decorating portion.

3. The slip-proof hand tool as claimed in claim 1, wherein the hand tool body has two working ends respectively connected with the ends of the handle.
